(19) United States
(12) Patent Application Publication
(10) Pub. No.: US 2004/0236557 A1
(43) Pub. Date: Nov. 25, 2004

(54) Method for simulation of electronic circuits and N-port systems

(76) Inventor: Sunil C. Shah, Los Altos, CA (US)

Correspondence Address: Arlen M. Hartounian, BLAKELY, SOKOLOFF, TAYLOR & ZAFMAN LLP, Seventh Floor, 12400 Wilshire Boulevard, Los Angeles, CA, 90025, US

(21) Appl. No.: 10/850,794

(22) Filed: May 21, 2004

Related U.S. Application Data
(60) Provisional application No. 60/473,047, filed on May 22, 2003.

(51) Int. Cl. G06F 17/50

(52) U.S. Cl. 703/14

(57) ABSTRACT

According to an embodiment of the invention, a system and method for performing simulations is provided. Using parallelism in systems, the method decomposes a larger problem into several smaller partitions. A series of iterations is performed until the waveforms exchanged between the partitions converge. Approximate pre-view solutions of strongly coupled partitions are introduced to reduce the number of iterations required for convergence. These approximate pre-view solutions are introduced before the simulations occur. Once the waveforms converge, the simulation has determined a solution.

### RELATED APPLICATION

This application claims priority of U.S. provisional application Ser. No. 60/473,047, filed on May 22, 2003, entitled “Method for fast, accurate simulation of electronics circuits and physical n-port system.”

### FIELD OF THE INVENTION

The current invention generally relates to simulations, and specifically to accurate waveform level computer simulations of large complex systems.

### BACKGROUND

Simulations can be carried out using computer systems so that a designer or developer can test a design before producing it. For example, a designer can build a complex circuit using a computer application. The application can then simulate the output of the circuit at certain times given certain inputs. Using the simulation, the designer can easily prototype several circuits and test them without actually having to build them.

Simulations often require extensive computing resources. One way to provide these resources in an inexpensive manner is to use clusters of machines that operate in parallel. For example, several computer systems can be networked together to collectively work on a solution for a single problem. One challenge of performing these simulations in parallel is dividing and coordinating the work amongst the machines.

Circuit simulations are often performed using the Simulation Program With Integrated Circuit Emphasis (SPICE) simulator or its derivatives. These simulators use a numerical integration known as the “Direct Sparse” solution method. As circuits have become larger and as signal integrity effects have become more important, the time it takes to run these simulations has become prohibitive. These simulations typically involve transient behavior of the circuit and require solving the Initial Value Problem.

FIG. 1 is a flowchart illustrating a process for determining a solution to a simulation using the initial value problem. The process 100 can be used to determine a solution for a given portion of a larger simulation using the direct sparse method. For example, a circuit simulation can be divided into several blocks, each of which can be represented by differential algebraic equations (DAEs). According to one embodiment, the DAEs are provided using a modified nodal analysis (MNA). These equations can then be simplified and solved to reach a solution for the simulation.

The process 100 begins in start block 102. In block 104, the DAEs from the device models are supplied. For example, the DAEs may be of the form F(t,y,\dot{y})=0. In block 106, the Backward Difference formula is applied to the DAEs to obtain finite difference equations. The finite difference equations may be of the form

$$F ( {t}_{n} , {y}_{n} , \frac{{y}_{n} - {y}_{n - 1}}{{h}_{n}} ) = 0.$$

These are non-linear algebraic equations.

Since non-linear equations are difficult and computationally expensive to solve, in block 108, a Newton-Raphson (NR) iteration is performed to obtain linear algebraic equations. The NR iteration is of the form

$${y}_{n}^{ m + 1} = {y}_{n}^{ m} - {( \frac{\partial F}{h \partial {y}^{′}} + \frac{\partial F}{\partial y} )}^{- 1} F ( {t}_{ n} , {y}_{n}^{ m} , \frac{{y}_{ n}^{m} - {y}_{n - 1}}{{h}_{ n}} ) .$$

The resulting linear algebraic equations, of the form Ax=b can then be solved using a linear system solver in block 110.

Blocks 108 and 110 form an NR loop, which can be repeated until the solution of the linear system solver in block 110 converges. In block 112, it is determined whether the NR solution has converged. If it has, the process continues to block 114. If the solution has not converged, the NR loop repeats, and the process returns to block 108.

In block 114, if there are more time steps to be process, the process 100 returns to block 106, and a solution can be determined for a new point in time. If there are no more time steps, the process finishes in block 116. At that point, a solution for the problem has been obtained.

Verification of chip design requires running many transient simulations with different input waveforms or dynamic vectors. Parallel implementation of simulations can speed up the simulations. Communication overheads and the need to synchronize computations through communications can create bottlenecks in parallel implementations. Direct Sparse methods have provided limited performance gains in parallel implementations because of the communication and synchronization overheads. The NR iterations of the process 100 can be parallelized. This “parallelism in the method” requires communication synchronization across the entire circuit at time scales dictated by activities (i.e., a fast change in variable values) anywhere in the entire circuit.

“Parallelism in systems” has been proposed for circuit simulations. It is also referred to as “waveform relaxation” in the circuit simulation literature. This approach allows parallel simulation of the Initial Value problem (a time transient simulation) by exchanging entire waveforms across sub-circuits. However, in most practical circuits, because of feedback in strongly coupled systems, the resulting convergence slows down. As a result, the benefit of parallel implementations diminishes as a result of slow convergence, thereby requiring many relaxation iterations. To address this problem, separate approaches have been proposed dealing with local (loading at a terminal) and global (across many terminals and sub-circuits) strong coupling. In practice, either the partitions become so large that effective parallelization of computation load is not achieved or the communication and synchronization overheads make the method ineffective. What is needed is a method that reduces the time required for performing parallelized simulations and takes into account both local and global strong coupling.

### SUMMARY OF THE INVENTION

According to an embodiment of the invention, a system and method for performing simulations is provided. Using parallelism in systems, the method decomposes a larger problem into several smaller partitions. A series of iterations is performed until the waveforms exchanged between the partitions converge. Approximate pre-view solutions of strongly coupled partitions are introduced to reduce the number of iterations required for convergence. These approximate pre-view solutions are introduced before the simulations occur. Once the waveforms converge, the simulation has determined a solution.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 is a flowchart illustrating a process for determining a solution to a simulation using the initial value problem;

FIG. 2 illustrates a computer system on which an embodiment of the present invention can be implemented;

FIG. 3 illustrates a cluster of computer systems according to an embodiment of the invention;

FIG. 4 is a flowchart describing a process for partitioning a system and performing a simulation according to one embodiment of the invention;

FIG. 5 illustrates a strongly coupled multi-port nonlinear circuit;

FIG. 6 illustrates a strongly coupled circuit including an approximation according to an embodiment of the invention;

FIG. 7 illustrates a large partition decomposed into several smaller partitions;

FIG. 8 illustrates a pre-viewer circuit for the circuit 700 with m approximated partitions;

FIG. 9 illustrates several processors performing simulations for several different partitions;

FIG. 10 illustrates several processors running in parallel according to an embodiment of the invention;

FIG. 11 illustrates a pre-viewer for a strongly coupled circuit similar to the pre-viewer circuit 600;

FIG. 12 illustrates a circuit including many separate partitions similar to the circuit 800;

FIG. 13 illustrates a circuit exhibiting bi-directional local coupling;

FIG. 14 illustrates the slow convergence using a standard Gauss-Seidel decomposition;

FIG. 15 illustrates an approximation for the non-linear element G2;

FIG. 16 illustrates the circuit including a piece-wise linear approximation of the non-linear element G2;

FIG. 17 is a plot illustrating the accelerated convergence of the circuit;

FIG. 18 illustrates a bi-quadratic filter circuit;

FIG. 19 illustrates the circuit partitioned using a Gauss-Seidel decomposition;

FIG. 20 is a plot showing the convergence of a simulation of the circuit using Gauss-Seidel decompositions;

FIG. 21 illustrates a pre-viewer from decomposition of the circuit according to an embodiment of the invention;

FIG. 22 is a graph illustrating the convergence of the circuit decomposed according to an embodiment of the invention;

FIG. 23A illustrates a non-linear two dimensional mesh;

FIGS. 23B and 23C illustrate exploded views of the mesh;

FIG. 24 illustrates a graph showing a center node voltage for a tile from a full reference simulation and from a full order linear approximation of the circuit;

FIG. 25 illustrates the difference between the approximate low order pre-viewer response and the full reference system for a center node voltage of a tile; and

FIG. 26 is a graph showing the error of the voltage output of the simulation after three iterations using an embodiment of pre-viewer based approximation.

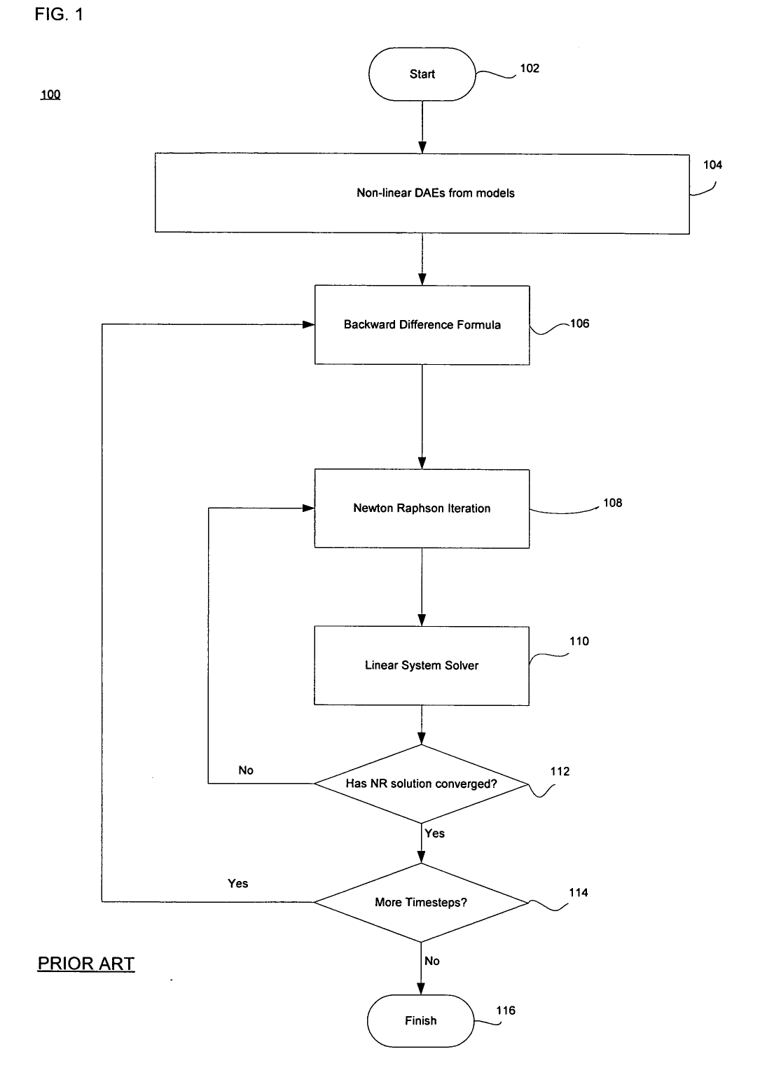

### DETAILED DESCRIPTION

Described herein is a method and systems for Simulation of Electronic Circuits and Physical N-Port Systems. Note that in this description, references to “one embodiment” or “an embodiment” mean that the feature being referred to is included in at least one embodiment of the present invention. Further, separate references to “one embodiment” or “an embodiment” in this description do not necessarily refer to the same embodiment; however, such embodiments are also not mutually exclusive unless so stated, and except as will be readily apparent to those skilled in the art from the description. For example, a feature, structure, act, etc. described in one embodiment may also be included in other embodiments. Thus, the present invention can include a variety of combinations and/or integrations of the embodiments described herein.

According to an embodiment of the invention, a system and method for performing simulations is provided. Using parallelism in systems, the method decomposes a larger problem into several smaller partitions. A series of iterations is performed until the waveforms exchanged between the partitions converge. Approximate pre-view solutions of strongly coupled partitions are introduced to reduce the number of iterations required for convergence. These pre-view solutions are introduced before the simulations begin to reduce the effects of both local and global coupling. Once the waveforms converge, the simulation has determined a solution. As will be explained below, the introduction of the approximation reduces the amount of computational time required for the waveforms to converge, and accounts for both local and global strong coupling.

Generally, it is advantageous to divide a large simulation into smaller partitions. The smaller partitions can more easily be parallelized, thereby reducing the time required for the simulation. In addition, the smaller partitions also require fewer total computations. Generally, simulations are parallelized by exchanging waveforms between the partitions. The waveforms represent outputs and inputs of specific partitions. The waveforms converge once the waveforms being exchanged approach a common value, resulting in a solution. Strong coupling between two partitions can increase the number of iterations (or exchanges of the waveforms between the two partitions) required for convergence.

Prior implementations were only able to deal effectively with local strong coupling. As will be shown using the examples that follow, by introducing a composite approximation (or a “pre-viewer”) into a simulation iteration before a simulation of partitions begins, the effects of both local and global coupling are substantially reduced. As a result, smaller partitions may be used while the exchanged waveforms converge more quickly. The result is that simulation time is substantially reduced, since more partitions leads to greater parallelization, smaller partitions require less computation, and the result of the reduced effects of strong coupling is that fewer iterations are required for convergence.

Although circuit simulations will be discussed extensively, it is understood that other simulations may benefit from the techniques described herein. For example, biological, chemical, and automotive simulations can be described in terms of networked n-ports. An n-port may be thought of as a partition of a larger system that can be networked with other systems. Any type of system that can be described in terms of n-ports can benefit from the disclosed techniques. For example, n-ports can describe values such as temperatures, velocity, force, power, etc. Several simulation standards, such as Verilog AMS, are now able to describe various systems in terms of n-ports.

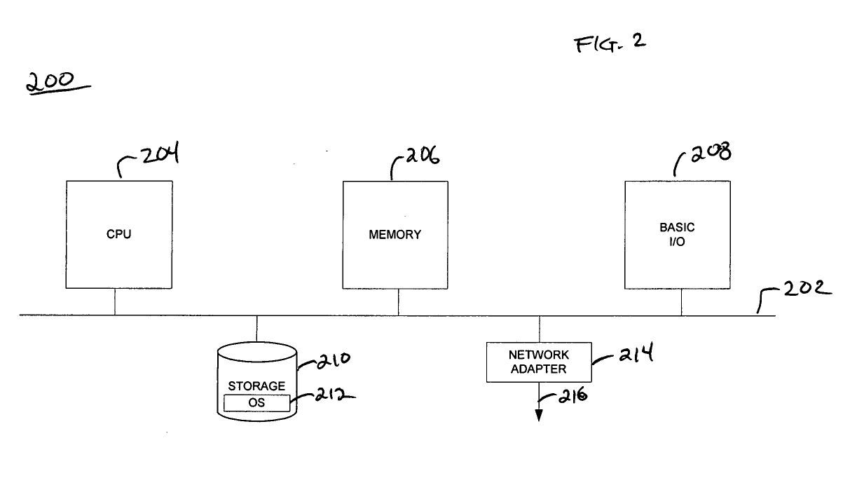

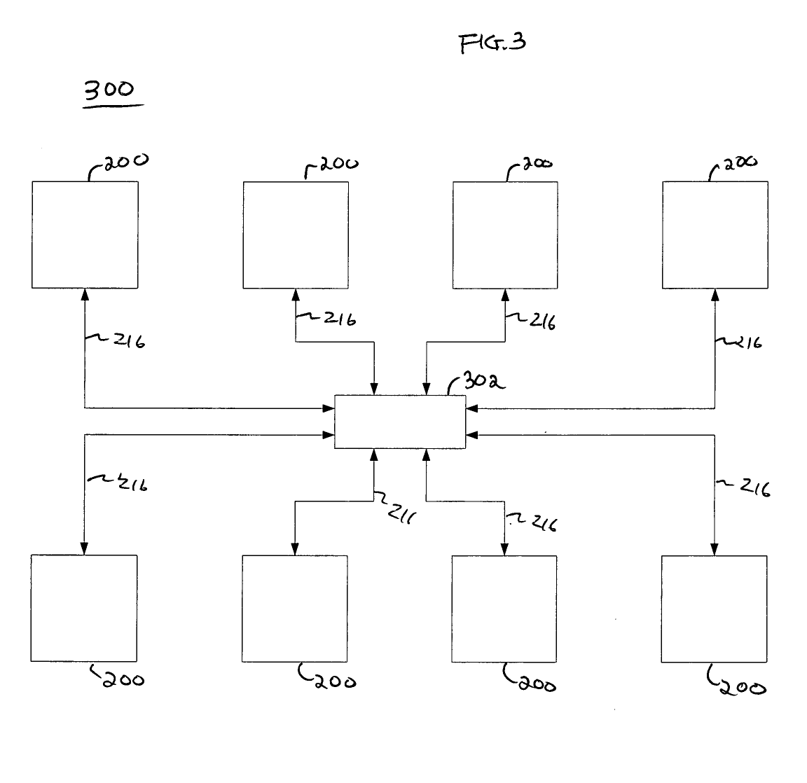

FIG. 2 illustrates a computer system on which an embodiment of the present invention can be implemented. The computer system 200 may be part of a larger cluster that will be described in FIG. 3. The computer system 200 includes a bus 202, which serves as a distribution channel for information throughout the computer system 200. A processor 204 is coupled to the bus 202. The processor 204 may be any suitable processor, including but not limited to those manufactured by Intel and Motorola. The processor 204 may also comprise multiple processors. A memory 206 is also coupled to the bus 202. The memory 206 may include random access memory (RAM), read only memory (ROM), flash memory, etc. A basic Input/Output unit 208 receives input from several sources such as keyboards, mice, etc., and outputs to output devices such as displays, speakers, etc. Storage 210 may include any type of permanent or transient storage including magnetic or optical storage such as hard drives or compact disc-read only memories (CD-ROM). A copy of an operating system (OS) 212 may be stored on the storage 210. The OS 212 includes the software necessary to operate the computer system 200, and may be a Unix derivative such as Linux, etc. It is understood that the OS 212 may also be any other available OS, such as Microsoft Windows or the Macintosh OS. A network adapter 214 connects the computer system 200 with other systems in a cluster, and with other networks such as the Internet through a connection 216. It is understood that the computer system 200 is only an example of computer systems that may be used to implement the invention, and that any other appropriate configuration may be used.

FIG. 3 illustrates a cluster of computer systems 300 according to an embodiment of the invention. Several computer systems 200 may be networked together using a peer-to-peer arrangement with a central switch or a router 302. Alternatively, one of the computer systems 200 in the networked system 300 may be a central server. Using this implementation, several inexpensive computer systems 200 can be networked into a cluster 300 to provide a powerful system through which parallelized problems can be solved.

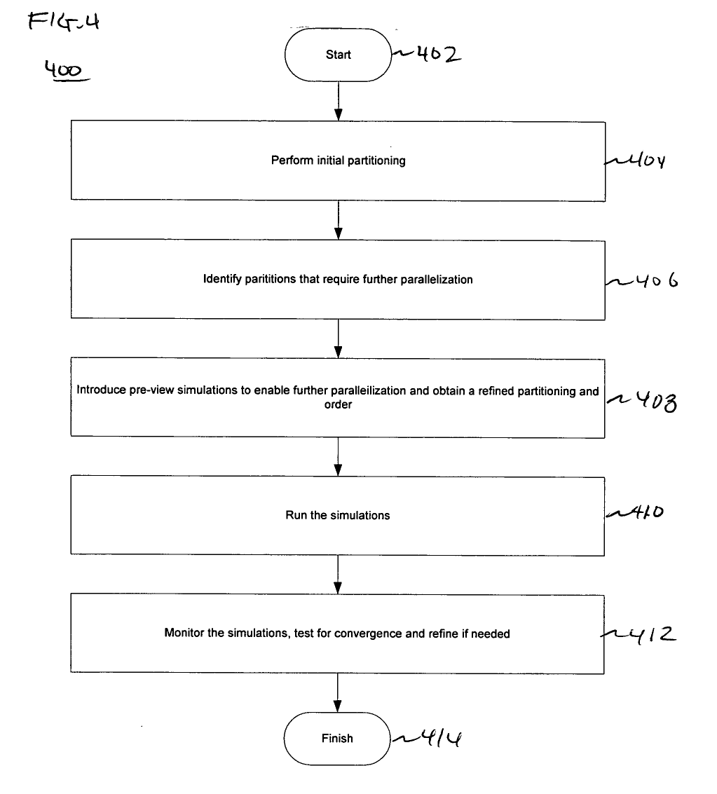

FIG. 4 is a flowchart describing a process for partitioning a system comprising n-ports or circuits and performing a simulation according to one embodiment of the invention. The process 400 describes dividing a larger system to be simulated into smaller partitions to be used with the parallel in systems method. As will be discussed below, by dividing the overall system into smaller blocks, the number of nodes N for each partition is reduced, and as a result, the total number of computations required is reduced. The computations consist of running waveform simulations of each partition for the number of waveform iterations required for convergence.

Large partitions, or those having many unknown node variables, typically require more computation during a waveform simulation than smaller partitions. For most purely digital circuits with no signal integrity effects, the computation costs per time point scale with the number of nodes N, roughly as N^{α}, where α ranges from 1.4 to 1.6. However, when signal integrity effects such as power grid mesh are included, α can be range from 1.8 to 2.4. In addition, for larger circuits the number of time points in the simulation is greater because of higher total activity. Together, these effects strongly favor running smaller partitions, provided the convergence rate and overheads are not adversely affected.

Generally, the fewer nodes or variables N a circuit has, the fewer computations that are required per time point. For example, in a system with α=2, a partition having 1000 nodes will require ˜1,000,000 floating point operations per time point in a waveform. On the other hand, if the 1000 node circuit is divided into 10 smaller circuits of 100 nodes each, each of those ten smaller circuits will only require ˜10,000 floating point operations per time point, for a total of ˜100,000 operations per time point In addition, for larger circuits the number of time points in the simulation are higher because of higher total activity.

The effects of strong coupling are balanced against the advantages of dividing the system into smaller and smaller partitions. For example, a partition may comprise a circuit that includes elements whose behavior depends heavily on the behavior of other elements of the circuit. If the partitioning divides these strongly coupled partitions, the resulting simulation typically will require many waveform iterations to converge. As a result, the increased number of iterations needed for convergence may outweigh the reduction in time required for simulating each waveform iteration because of the smaller partitions. The introduction of an approximation using the pre-viewer, as described below, reduces the effects of both global and local coupling, reducing the number of iterations required for convergence.

The process 400 begins in start block 402. In block 404, an initial partitioning of the full system into subsystems is created. This partitioning is completed based on weak coupling arising from inherent properties of the system. Effectively, the full system is scanned to determine a number of initial partitions and their order of simulation. These partitions are chosen so that they converge in relatively few iterations when simulated in the order of inherent coupling. Large initial partitions are the result of strong coupling within. As mentioned above, larger partitions require significantly more computation time for each waveform simulation. The longer time creates imbalance in computer loading which limits parallelization. In block 406, ordered partitions that require further parallelization are identified. These partitions are identified by examining the partitions generated in block 404 as being further divisible. The identified partitions are strongly coupled partitions that are larger than would be desired. In block 408, pre-viewer simulations are introduced to enable further parallelization and obtain a refined partitioning and order. The pre-viewer and its operation will be explained further below, but generally the pre-viewer comprises the approximation that will be introduced into a strongly coupled system to provide an approximate pre-view solution. The pre-viewer “pre-views” a solution to the simulator. Since the pre-viewer generates an approximation before the simulation of partitions begins, the system reduces the effects of local and global coupling, which will be explained below.

The pre-viewer determines the best candidates for further division. In block 410, the refined partition simulations are run, including the pre-viewer simulations in the new order on the computer platform. This operation is the performance of the simulation itself. The simulation may be performed using SPICE, Verilog AMS, or another simulation application.

In block 412, the progress of the simulation is monitored, and a test for convergence of the proposed divisions is performed. If needed, the divisions are further refined to produce the best set of blocks, and therefore the best simulation.

Simulation of dynamical systems arising in areas such as circuit simulation are typically described using an interconnection of n-ports. Simulation languages such as Verilog AMS enable designers to describe large scale systems hierarchically in terms of n-ports. Circuit simulators such as SPICE permit hierarchical description in terms of n-port sub-circuits. Any n+1 terminal device can be described as an n-port sub-circuit. Each n-port is internally described as a set of differential and algebraic equations. Interconnections at ports result in further constraints such as Kirchoff's Current Law (KCL) or Kirchoff's Voltage Law (KVL).

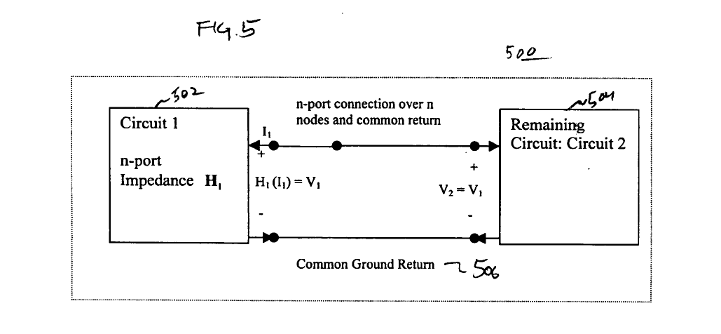

FIG. 5 illustrates a strongly coupled multi-port nonlinear circuit. The circuit 500 includes circuits 502 and 504, which may be described as individual n-ports. The circuit 500 is the result of partitioning 404 described. The circuit 500 may be a partition that is too large, and will therefore increase the time required for the simulation. However, the circuit 500 is also strongly coupled, and if divided, will converge too slowly. The larger circuit 500 may be preliminarily divided into the two circuits 502 and 504, where the circuit 502 can be approximated, and the circuit 504 is the remainder of the original circuit 500.

Assume that the circuit 502 has been represented as an n-port Impedance H₁ and the circuit 504 is the remainder of the larger partition 500. The circuit 502 may be an n+1 terminal circuit, where n is the number of ports found in the circuit and where the circuit 502 shares a common ground 406 with the remainder of the circuit 504.

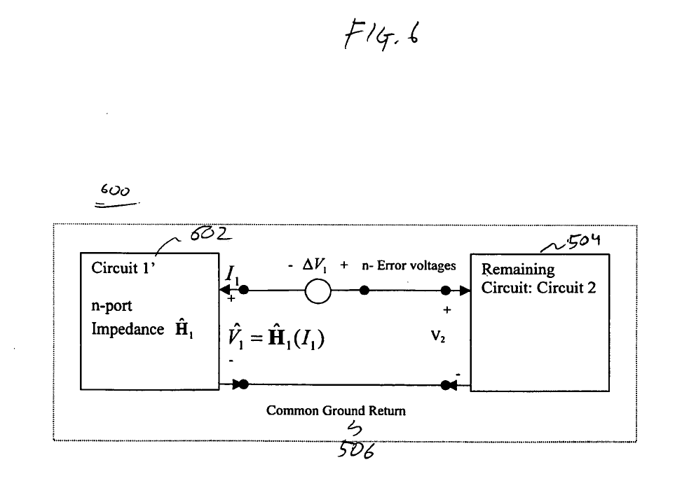

If the circuit 500 is transformed by introducing a computationally cheap approximation in place of the circuit 502, say Ĥ₁, the convergence can be accelerated. FIG. 6 illustrates a strongly coupled circuit 600 including an approximation according to an embodiment of the invention. The circuit 600 is a pre-viewer of the circuit 500, replacing the circuit 502 with an approximation circuit 602. The remaining circuit 504 is the same as above. As long as the approximation Ĥ₁ is reasonable as described later, the pre-viewer circuit 600 becomes weakly coupled to the original circuit partition 502 H₁, and the convergence of the pre-viewer circuit 600 and the circuit 502 will occur much more quickly. The approximation Ĥ₁ is chosen to be computationally inexpensive so that the pre-viewer circuit 600 simulation takes about the same as time as the simulation of partition H₂ and that of partition 502 H₁.

The waveform iterations for the simulation are described below:

1) k=1; Initialize waveforms ΔV₁^{k-1}=0

2) ΔV₁^{k-1} [symbol] {I₁^{k},\hat{V}₁^{k}} by simulating the pre-viewer circuit 600,

3) I₁^{k} [symbol] V₁^{k} by simulating the partitioned standalone impedance circuit 502 H₁, giving the voltage waveforms ΔV₁^{k}=V₁^{k}k−\hat{V}₁^{k}

4) if ∥ΔV₁^{k-1}−ΔV₁^{k}∥>tol then k=k+1, go back to operation 2) otherwise end.

The value k is incremented for each iteration. In the first operation 1) variables are initialized.

In the second operation 2), ΔV₁^{k-1} [symbol] {I₁^{k},\hat{V}₁^{k}} is determined. The value ΔV₁^{k-1} corresponds to the difference between the actual voltage waveforms and the approximate voltage waveforms for the previous iteration k−1. This value is inputted into the circuit 600, a simulation is run, and the values for the current waveforms and an approximation of the voltage waveforms for this iteration are determined using the pre-viewer. In the third operation 3), the determined value for the current waveforms is input into the circuit to determine a value for the voltage waveforms for this iteration. The difference between the actual and the approximate value for this iteration ΔV₁^{k} can then be determined. In the operation 4), if the norm of the difference between waveforms ΔV₁^{k-1} and ΔV₁^{k} is greater than a predetermined tolerance, the iterations continue, and the process returns to the operation 2). If the difference is less than the tolerance, the waveforms have converged, and the simulated values of the circuit 602 have been determined. Computation of the norm of the waveforms and the choice of approximation in the pre-viewer will be described further below.

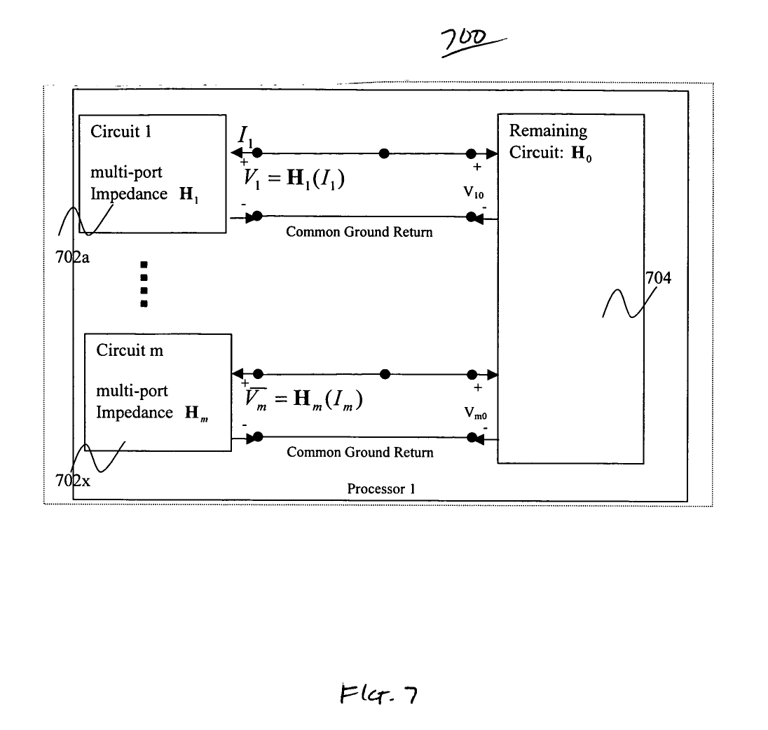

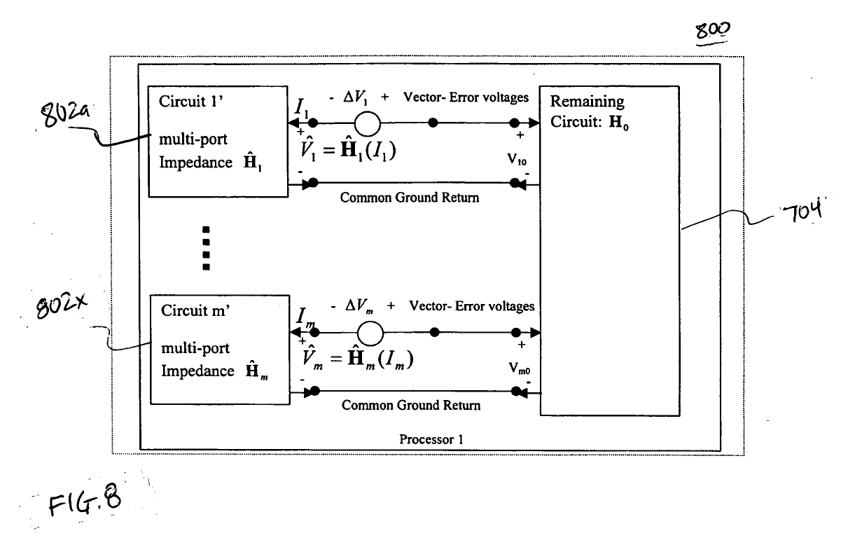

In some cases, it may be necessary to introduce several approximations into a single partition. FIG. 7 illustrates a large partition decomposed into several smaller partitions. As illustrated in FIG. 7, the circuit 700 is a large partition remaining from an initial partitioning. The circuit 700 is strongly coupled, so it has been divided into several subcircuits 702a-702x, where x is an arbitrary number of partitions equal to the m approximated partitions. The subcircuits 702a-702x are all coupled to the remainder of the circuit 700 H₀ 704, which typically comprises simple passive elements such as resistors. FIG. 8 illustrates a pre-viewer circuit 800 for the circuit 700 with m approximated partitions. The subcircuits 702a-702x each have been replaced by an approximation Ĥ₁ through Ĥₘ 802a through 802x. The remainder circuit H₀ 804 is the same as the remainder 704.

The waveform iterations for convergence of the circuit 800 proceed as:

1) Initialize k=1. Waveforms ΔVᵢ⁰=0 for i=1, . . . m

2) ΔVᵢ^{k-1} [symbol] {Iᵢ^{k},\hat{V}ᵢ^{k}} by simulating the pre-viewer 800. 704-(802a . . . 802x).

3) Iᵢ^{k} [symbol] Vᵢ^{k} by simulating each of the partitioned standalone Impedance multi-port Circuit Vᵢ^{k}=Hᵢ(Iᵢ^{k}), i=1, . . . m, gives waveforms ΔVᵢ^{k}=Vᵢ^{k}−\hat{V}ᵢ^{k}. This operation can be done in parallel.

4) if ∥ΔVᵢ^{k-1}−ΔVᵢ^{k}∥>tol for any i=1, . . . m then k=k+1, go back to operation 2), otherwise end.

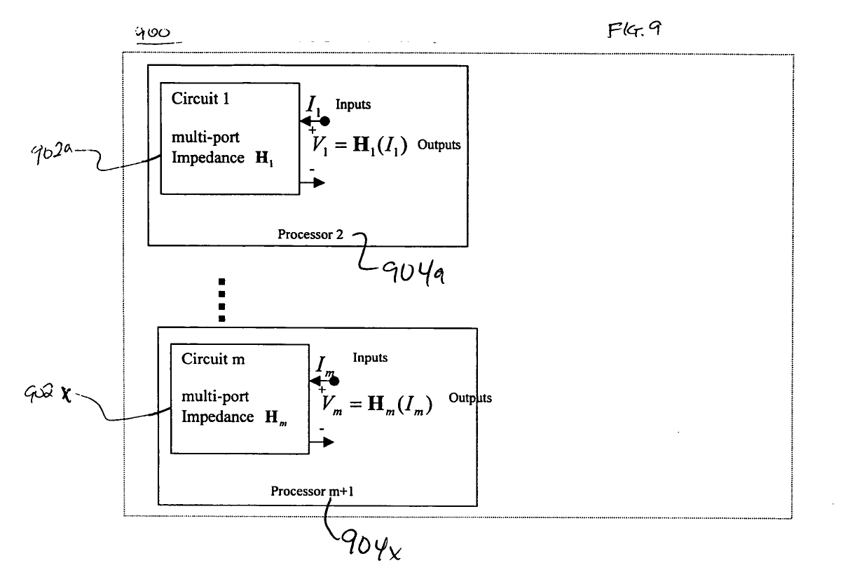

This process is similar to the process described above regarding FIG. 6. In this case, however, there are several different partitions for which simulations must be performed. The value i is incremented for each partition. FIG. 9 illustrates several processors performing simulations for several different partitions. As shown in FIG. 9, the third operation 3) can be parallelized, by running a simulation of each original partition 902a-902x on a separate processor 904a-904x once the current waveforms Iᵢ^{k} are available from the pre-viewer in the second operation 2). Otherwise, the process is the same as explained above regarding FIG. 6.

As mentioned above, the third operation 3) can be parallelized but follows serially after the second operation 2). When the computation cost of the composite approximation is less than that of each individual circuit partition Vᵢ^{k}=Hᵢ(Iᵢ^{k}), further parallelization of the second and third operations 2) and 3) can be achieved. FIG. 10 illustrates several processors running in parallel according to an embodiment of the invention. In one embodiment, the several partitions are chosen so that each partition requires approximately the same amount of computation time for the simulation.

FIG. 10 illustrates the actions of several processors 1002, 1004, and 1006 along a timeline 1008 while parallelizing the simulation process described above. The time tₛᵢₘ is the time for each iteration of the simulation. The simulation interval during an iteration is divided in to time segments. FIG. 10 illustrates an example with two time segments each requiring equal computation time tₛᵢₘ/2. The first processor 1002 is generally assigned the calculation of the pre-viewer. The second and third processors 1004 and 1006 are assigned individual partitions, and simulate these partitions. In this example, the first processor 1002 runs the composite approximation (pre-viewer), the second processor 1004 runs the first partition 902a and the third processor 1006 runs the second partition 902b. For example, the first processor 1002 runs a composite approximation 1012 during the first half of the iteration 1010a. When the approximation 1012 is complete, it is transferred to the processors 1004 and 1006, where each processor 1004 and 1006 simulates an individual partition during the second half of the iteration. In other words, during the period of time between t₀ and t₀+tₛᵢₘ/2, the first processor 1002 is calculating the pre-viewer 1012, which will be used by the processors 1004 and 1006 to run their simulations 1014 and 1016, respectively. In the time period between t₀+tₛᵢₘ/2 and t₀+tₛᵢₘ, the first processor 1002 will calculate the pre-viewer simulation of the second half of the first iteration. During this time, the processors 1004 and 1006 run the simulations for the first half of the iteration, using the pre-viewer generated by the processor 1002 during the time t₀ and t₀+tₛᵢₘ/2. Between the time t₀+tₛᵢₘ and t₀+1.5*tₛᵢₘ, the processors 1004 and 1006 run simulations 1018 and 1020 using the pre-viewer solution 1022 generated by the processor 1002 during the time t₀+tₛᵢₘ/2 and t₀+tₛᵢₘ. This process continues until the simulations have converged.

More specifically, at the end of first half of the simulation interval 1010, port current waveforms Iᵢ¹, i=1,2 for the first half interval of the iteration 1010a become available to the processor 1002. These current waveforms are transferred to the processors 1004 and 1006 assigned to run the standalone partitions. Standalone partitions begin their simulations for the first half interval while the processor 1002 runs a simulation for the second half of the simulation interval. When the processors 1004 and 1006 complete simulations of the first half of interval at time t₀+tₛᵢₘ, they provide the voltage waveforms Vᵢ¹, i=1,2 from the partitions for the first half interval to the composite approximation on the processor 1002 to be used during the next iteration. This allows the processor 1002 at time t₀+tₛᵢₘ to proceed with the simulation of the first half interval for the second iteration. The pipelined evaluation enables efficient parallel execution of the method.

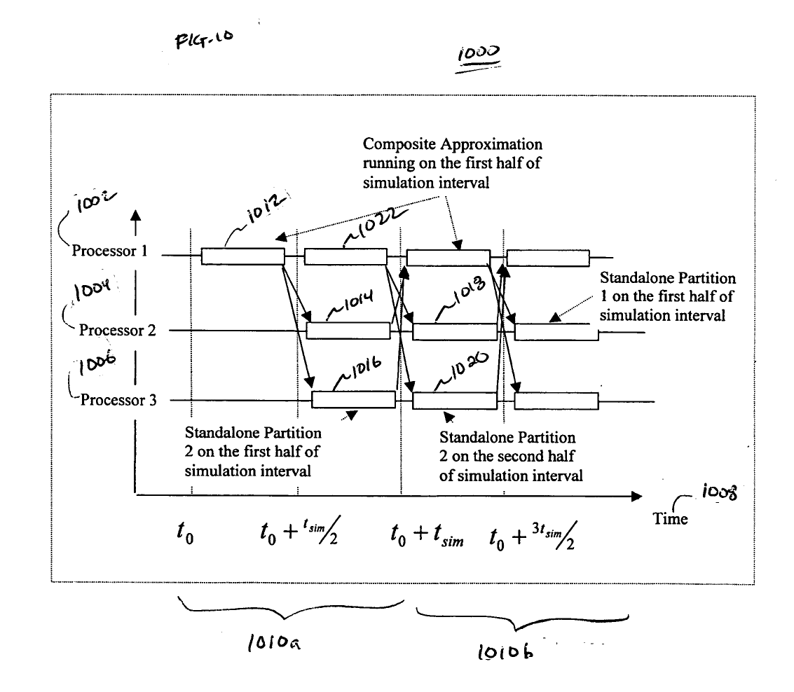

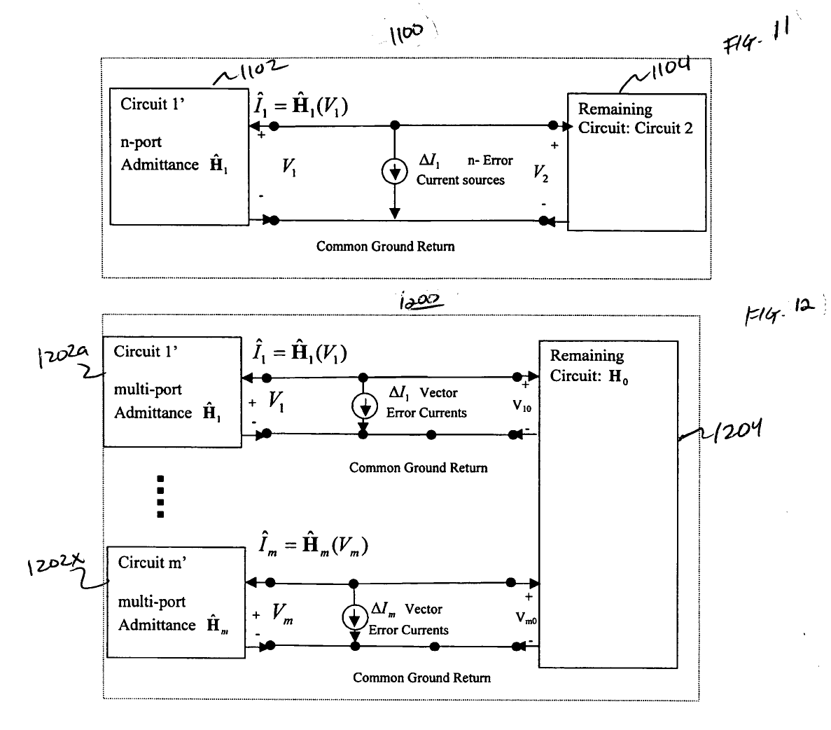

FIGS. 11 and 12 illustrate an embodiment of the invention using admittances and currents rather than impedances and voltages. FIG. 11 illustrates a pre-viewer 1100 for a strongly coupled circuit similar to the pre-viewer circuit 600. The circuit 1100 includes an approximation circuit 1102 and the remainder of the circuit 1104. FIG. 12 illustrates a circuit 1200 including many separate partitions similar to the circuit 800. The circuit 1200 includes several partitions 1202a-1202x, and the remainder of the circuit 1204. Similar to the impedance and voltage n-ports described above, the waveform iterations proceed as follows:

1) Initialize k=1. Waveforms ΔIᵢ⁰=0 for i=1, . . . m

2) ΔIᵢ^{k-1} [symbol] {Vᵢ^{k},Îᵢ^{k}} by simulating the pre-viewer system 0-1shown in FIG. 11 above.

3) Vᵢ^{k} [symbol] Iᵢ^{k} by simulating each of the partitioned standalone Admittance Multi-port Circuit Iᵢ^{k}=Hᵢ(Vᵢ^{k}), i=1, . . . m ,gives waveforms ΔIᵢ^{k}=Iᵢ^{k}−Îᵢ^{k}. This operation can be done in parallel.

4) if ∥Δᵢ^{k-1}−ΔIᵢ^{k}∥>tol for any i=1, . . . m then k=k+1, go back to operation 2) otherwise end

As used here, i=1 for the first partition 1202a, and i=m for the last partition 1202x. As before, waveforms ΔIᵢ^{k} measure the difference between the actual calculated value of the current and the approximated value. In the fourth operation 4), if the norm of difference between the waveforms ΔIᵢ^{k} of the previous iteration and the current iteration is less than the tolerance tol, the iterations have converged, and the simulation for this partition is complete. In FIG. 8 and FIG. 12 any one n-port can be a hybrid multi-port. The corresponding inputs and outputs are a hybrid (combination) of voltages and currents. The waveform iterations are modified for the appropriate input and output waveforms for the circuits.

There are several advantages to this approach. Because a generally strongly coupled non-linear multi-port system is considered, both global and local feedback situations are addressed together. Previous methods attempted to address local feedback arising from loading at a single terminal separately from global feedback. These prior methods exploited the specific uni-directional structure of MOS circuits. In the presence of strong local bi-directional coupling this led to convergence difficulties. Prior methods also suffered from slow convergence in the presence of strong global coupling.

The present method applies to any simulation that maps a non-linear waveform to a non-linear waveform in a Banach space. The corresponding Banach space norm is used in convergence test during iterations and for computing incremental operator gains for approximations below. Therefore, it does not use specific structure of the multi-port system to derive its benefits. Any simulator that exploits structure of the underlying domain can be used to exploit the structure in addition to the benefits derived from this method. For example, in circuit simulators such as SPICE, a sparsity structure of the underlying circuit equations is exploited by the simulator itself. Using SPICE in simulating individual components allows exploitation of sparsity structure of the circuit equations.

Composite approximations can be simulated using a variety of approaches. For example, in MOS circuit simulators, a composite approximation can be constructed using table driven piece-wise approximate models in an event driven simulation. Such simulators, also referred to as fast timing simulators, provide approximate waveforms at speeds of 10-1000 times faster than SPICE. However, the approximate waveforms are accurate only to within 5-10%. Another example of an approximate simulation is using Model Order Reduction (MOR). For large RLC networks, MOR provides orders of magnitude faster computations at the expense of introducing errors up to 10%.

Any domain specific simulators and domain specific approximation can be used, provided the approximation meets conditions for convergence. What is remarkable is that rather crude approximations lead to fast convergence.

The following description describes the process of choosing an approximation that will be used in the processes above. A pre-viewer for a strongly coupled system comprises a composite approximation having the following properties:

1) The pre-viewer can be simulated in its own simulator in a time comparable to the time required to accurately simulate each original component n-port. This was explained above regarding the pipelined process in FIG. 10.

2) The remaining circuit H₀ is trivial, typically comprising passive devices such as resistors or nodes.

3) Each approximated component n-port Ĥᵢ meets an error test with respect to Hᵢ. This is a test for incremental operator gain of Hᵢ-Ĥᵢ.

Candidates for approximation include simulations with simplified table look up models, switch level simulations, macro models, and reduced order models. These approximations may involve pre-characterization for re-used components. Additionally, there is a tradeoff between quality of the approximation and its run-time speed. At the time of pre-characterization the error between Hᵢ and Ĥᵢ is computed using the following:

Let u_{1,} u₂, . . . , u₁ be distinct input vectors used in fitting Ĥᵢ.

Let y₁, y₂, . . . , y₁ be the output vectors from running Hᵢ with the inputs:

yⱼ=Hᵢ(uⱼ)

Let ŷ₁, ŷ₂, . . . , ŷ₁ be the output vectors from running Ĥᵢ with the inputs:

ŷⱼ=Ĥᵢ(uⱼ)

Here, uⱼ represents input waveform values, yⱼ=Hᵢ(uⱼ) represents actual waveform output of the partition Hᵢ given the input uⱼ, and ŷⱼ=Ĥᵢ(uⱼ) represents approximate outputs for the partition given the input uⱼ. To determine an error for the approximation, an estimate of the incremental operator gain is computed:

$${\hat{γ}}_{i} = {max}_{j , {j}^{′}} \frac{‖ ( {y}_{j} - {\hat{y}}_{j} ) - ( {y}_{{j}^{′}} - {\hat{y}}_{{j}^{′}} ) ‖}{‖ ( {u}_{j} - {u}_{{j}^{′}} ) ‖}$$

where the norm of the input or output vector waveform is:

$$‖ y ‖ = {( {\int }_{0}^{T} {\vert y ( t ) \vert}^{2} ⅆ t )}^{1 / 2}$$

At any given time t, y(t) is a vector of voltage or current variables, |y(t)| denotes a norm in the linear space of ordered real n-tuples. For example, if y(t) is composed of four voltages, y(t)=[V1(t),V2(t),V3(t),V4(t)], then |y(t)|=max[abs(V1(t)),abs(V2(t)),abs(V3(t)),abs(V4(t))], or alternately |y(t)|=(V1²(t)+V2²(t)+V3²(t)+V4²(t)^{1/2}.

In alternate embodiments, for linear operators,

$${\hat{γ}}_{i} = {max}_{ω} {σ}^{2} \{ {H}_{i} ( ω ) - {\hat{H}}_{i} ( ω ) \} ;$$

the H_{∞}-norm. Standard software such as MATLAB (from Mathworks) also provide tools for computing it. If a component is mildly non-linear, a linearized version of the operator may be used in computing the H_{∞}-norm.

In alternate embodiments other function space norms such as Lₙ^{∞}-norm can be used. In that case, consistent incremental operator gains \hat{γ}ᵢ have to be computed. According to one embodiment of the invention, \hat{γ}ᵢ should be as small as possible to achieve good approximations. A number of potential candidate approximations can be considered, Ĥᵢ_{ⱼ}=1, 2, . . n of a sub-system Hᵢ. Assume that all of the allow meeting pre-viewer run-time constraint. Then, the system chooses the approximation with the lowest \hat{γ}ᵢ.

The remaining description describes several examples of the techniques described herein. These descriptions are understood to be examples, and it is further understood that there are several other possible implementations and embodiments of the described invention.

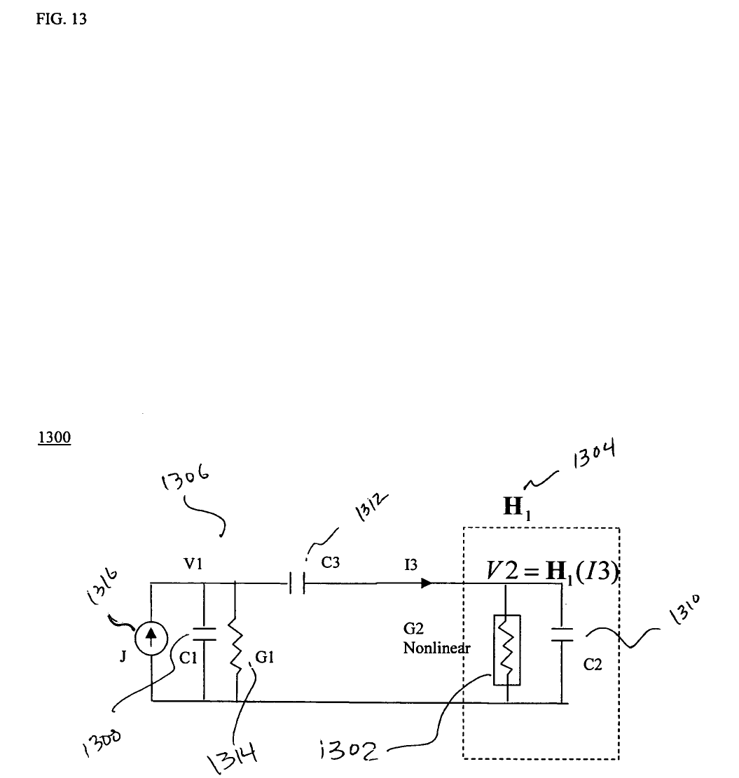

FIGS. 13-17 illustrate the simulation of a circuit exhibiting bi-directional local coupling according to an embodiment of the invention. FIG. 13 illustrates a circuit exhibiting bi-directional local coupling. The circuit 1300 is a strongly coupled circuit that includes a non linear element G2 ports 1302 that can be described by two parallel diode equations: i₂=g2*v₂+I₀*(e^{v}^{₂}^{/Φ}^{_{T}}−e^{(V}^{_{T}}^{-v}^{₂}^{)/Φ}^{_{T}}). The circuit 1300 will be partitioned into a first partition 1304 designated H₁, and the remainder of the circuit 1306. The circuit 1300 also includes three capacitors C1 1308, C2 1310, and C3 1312, a linear element G1 1314, and a current source J 1316.

Standard nodal analysis (using Kirchoff s current law) gives the two coupled differential equations:

(C1+C2)*\dot{v}₁−C3*\dot{v}₂+G1*v₁=J

v₁(0)=v1

(C3+C2)*\dot{v}₂−C3*\dot{v}₁+i₂(v₂)=0

v₂(0)=v2

Previous methods for decomposing this circuit into partitions using Gauss-Seidel iterations results in the following equations:

(C1+C2)*\dot{v}^{k}₁−C3*\dot{v}^{k-1}₂+G1*v^{k}₁=J

v^{k}₁(0)=v1

(C3+C2)*\dot{v}^{k}₂−C3*\dot{v}^{k}₁+i₂(v^{k}₂)=0

v^{k}₂(0)=v2

Note that each differential equation can be solved separately using \dot{v}^{k-1}₂,\dot{v}^{k}₁ respectively as sources through the coupling capacitor C3 1312. The terms C3*\dot{v}^{k-1}₂,C3*\dot{v}^{k}₁, represent an approximation of the loading effect from the other circuit.

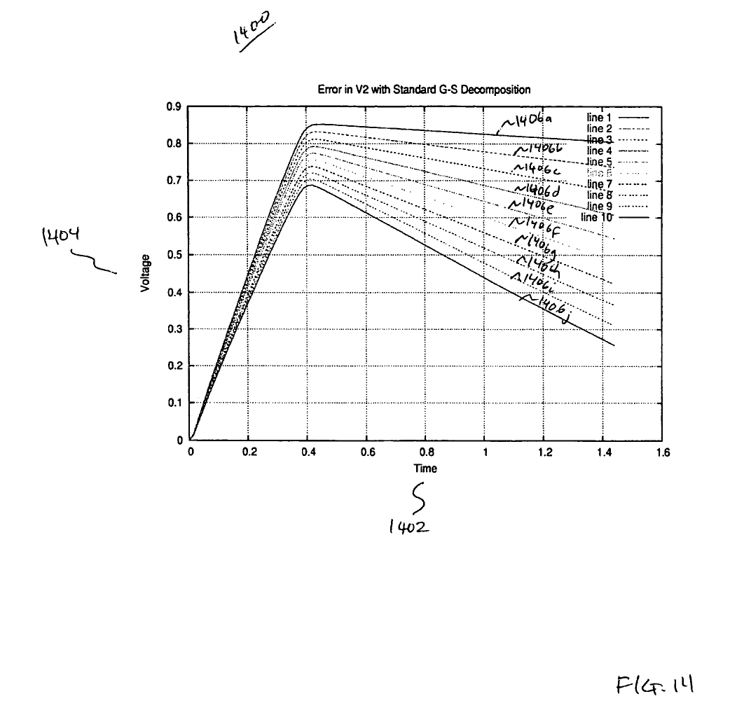

When the coupling capacitor C3 1310 has a large capacitance compared to the other capacitors C1 1308 and C2 1310, the rate of convergence is slow. FIG. 14 illustrates the slow convergence using a standard Gauss-Seidel decomposition. The graph 1400 has time plotted along the x-axis 1402, and voltage along the y-axis 1404. Each of the plot lines 1406 illustrates an error for each progressive iteration of the simulation using the prior Gauss-Seidel decomposition compared to an actual value for the circuit 1300. The graph 1400 shows the simulation slowly converging through ten iterations. The plot line 1406a shows the error for the first iteration, and the plot line 1406j shows the error for the tenth iteration. Although the simulation is slowly converging toward the correct solution, even after the tenth iteration the error exceeds 0.6V at some timepoints. It is clear that such low convergence rates would be unacceptable in practice. Heuristic partitioning algorithms using the prior method would not partition the circuit 1300. However, doing so in larger circuits leads to insufficient granularity for parallel computation.

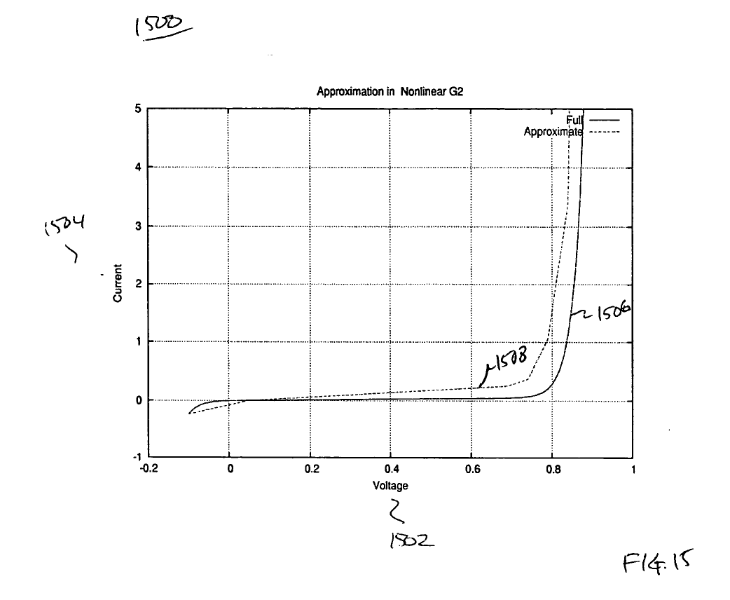

FIG. 15 illustrates an approximation for the non-linear element G2 1302. The graph 1500 shows a plot of voltage on the x-axis 1502 versus current on the y-axis 1504. The full, simulated plot 1506 is shown in the graph 1500. The approximated value is shown using the plot 1508. The approximated value is obtained using techniques described herein, such as using a coarse piece-wise linear table lookup.

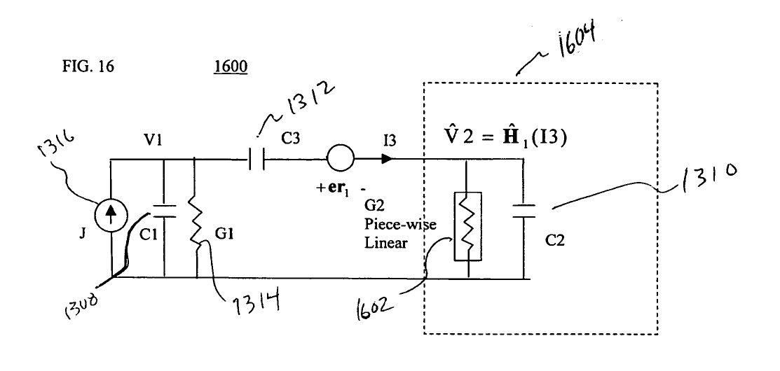

FIG. 16 illustrates the circuit 1300 including a piece-wise linear approximation 1508 of the non-linear element G2. The pre-viewer circuit 1600 is the circuit 1300 including the approximation 1602 in place of the original non-linear element 1302. The partition 1604 replaces the partition 1304 as described in FIGS. 5 and 6.

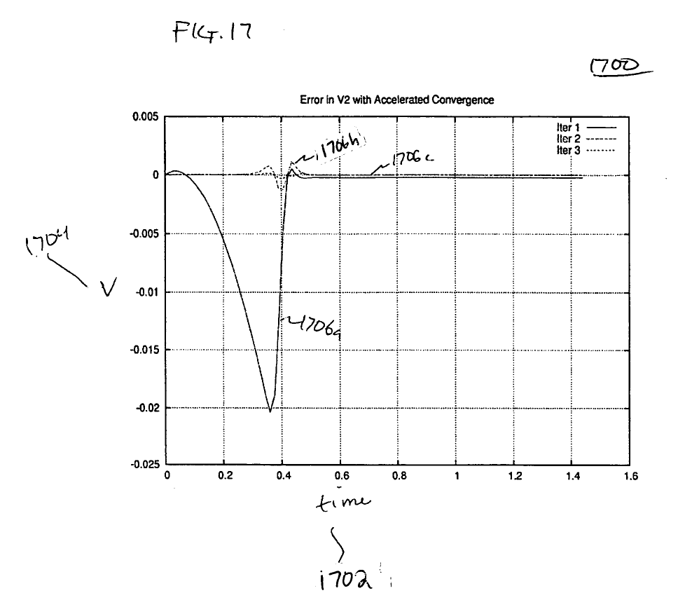

FIG. 17 is a plot illustrating the accelerated convergence using the pre-viewer circuit 1600. Like the plot 1500, the plot 1700 shows time along the x-axis 1702, and voltage along the y-axis 1704. The voltage in the plot is the error from the actual output generated by the circuit 1300. Note that the scale on the y-axis 1704 is much smaller than the scale on the y-axis 1504, above, indicating that even for the first iteration 1706a, the error is much smaller than the error for the tenth iteration 1506j. By the third iteration 1706c, there is very little error, and the simulation is very close to the actual calculated value for the circuit 1300. The result is that using the embodiments of the invention described herein, the iterations converge much more quickly than without the approximation.

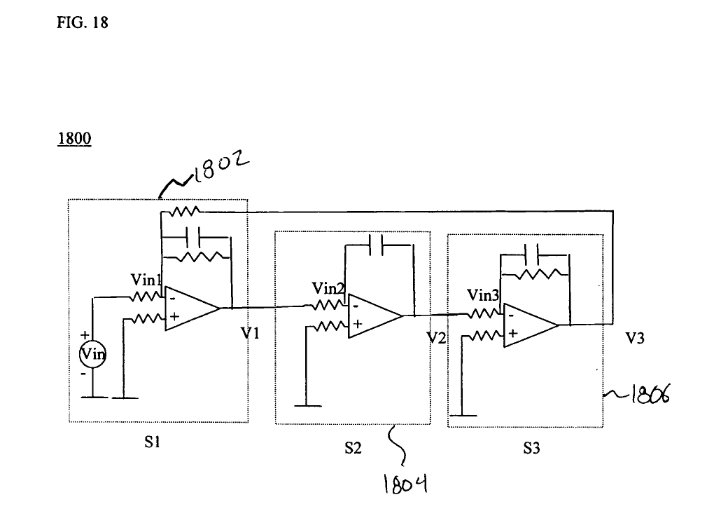

FIGS. 18-22 illustrate uni-directional global and local bi-directional coupling and their simulation according to one embodiment of the invention. FIG. 18 illustrates a bi-quadratic filter circuit 1800. The circuit 1800 includes three operational amplifier stages 1802, 1804, and 1806. The idealized filter transfer function from input voltage to output voltage is second order with an oscillatory response. The actual response has nonlinear effects such as slew rate in operational amplifiers and clamping. In addition, higher order parasitic poles and zeros are present in the linearized transfer function. Considering each operational amplifier stage 1802, 1804, or 1806 as a sub-circuit, it is evident that there is a strong global coupling creating the oscillatory response as one traverses the uni-directional input-output signal flow of the functional blocks. In addition to the global coupling, there is a local bi-directional loading effect at every connecting node. The global coupling is fast acting and strong.

FIG. 19 illustrates the circuit 1800 partitioned using a Gauss-Seidel decomposition. The decomposition 1900 shows the circuit 1800 divided into several ordered partitions 1902, 1904, and 1906. These partitions are made using the known Gauss-Seidel decomposition.

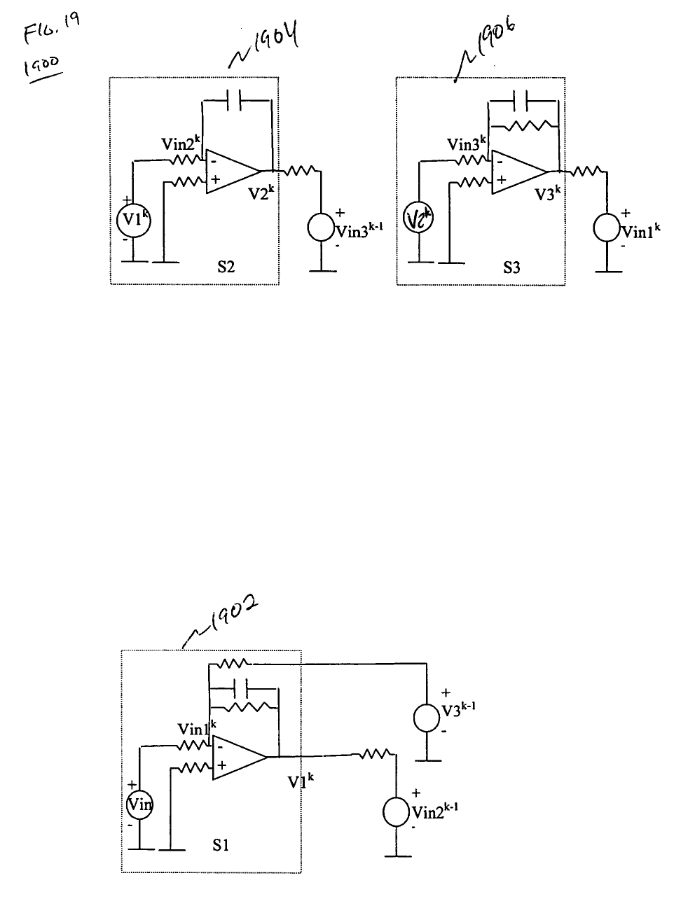

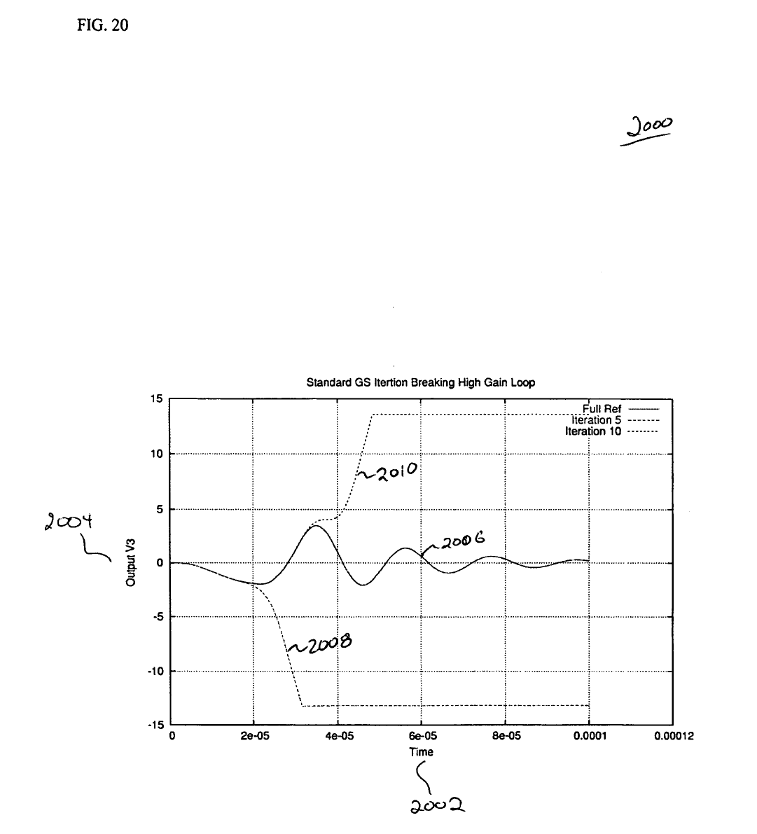

FIG. 20 is a plot showing the convergence of a simulation of the circuit 1800 using the Gauss-Seidel decomposition. The graph 2000 shows time along the x-axis 2002, and voltage along the y-axis 2004. The plot 2006 shows the actual response of the circuit 1800. The plot 2008 shows the output after five iterations using the Gauss-Seidel decomposition 1900. The plot 2010 shows the output after ten iterations using the Gauss-Seidel decomposition 1900. As can be seen, the waveforms are converging very slowly.

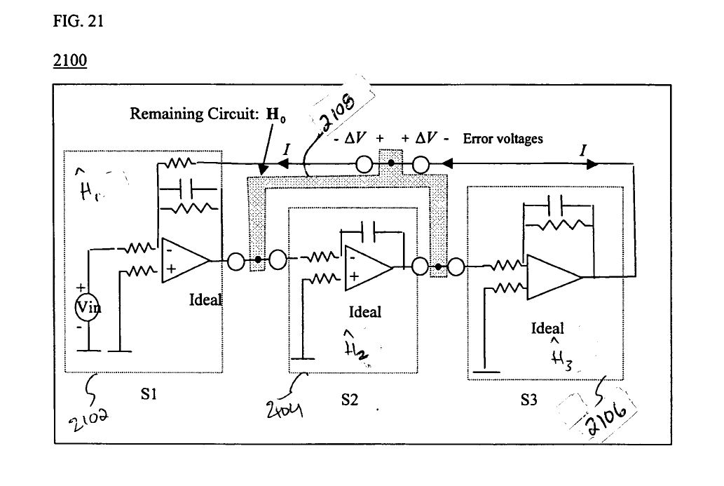

According to an embodiment of the invention, the circuit 1800 can be decomposed in the same manner that the circuit 700 in FIGS. 7, 8, and 9 is decomposed. FIG. 21 illustrates a pre-viewer from decomposition of the circuit 1800 according to an embodiment of the invention. Each sub-circuit stage H₁ 1802, H₂ 1804, and H₃ 1806 is viewed as a non-linear 2-port impedance operator. The remaining circuit H₀ 2108 comprises only nodes with interconnecting wires. Approximation of each stage 2102, 2104, and 2106 is accomplished by replacing the full non-linear operational amplifier by an equivalent ideal voltage controlled voltage source.

FIG. 22 is a graph illustrating the convergence of the circuit 1800 decomposed according to an embodiment of the invention. The graph 2200 displays time on the x-axis 2202, and output voltage on the y-axis 2204. The plot 2206 is the full simulation. The plot 2208 is the output after the first iteration, and the plot 2210 is the output after the second iteration. As can be seen, the simulation converges very quickly when using the decomposition as shown in FIGS. 7, 8, and 9.

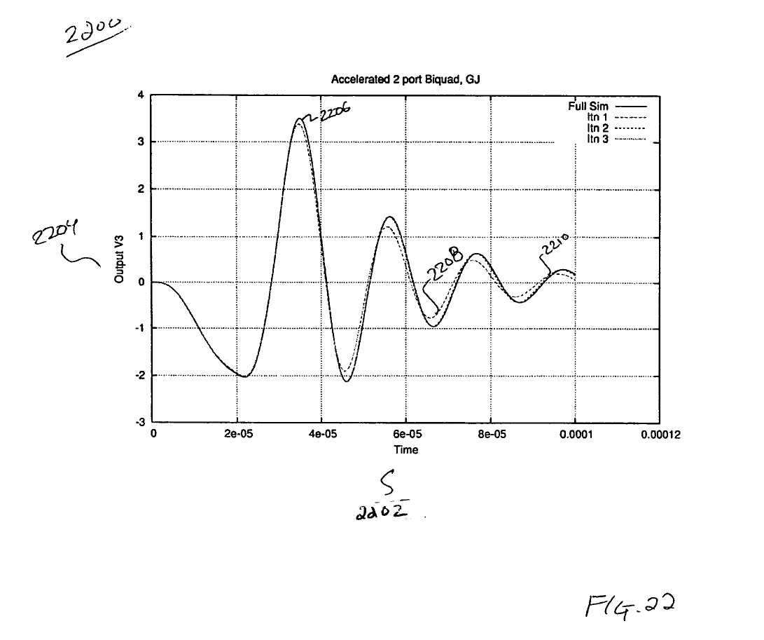

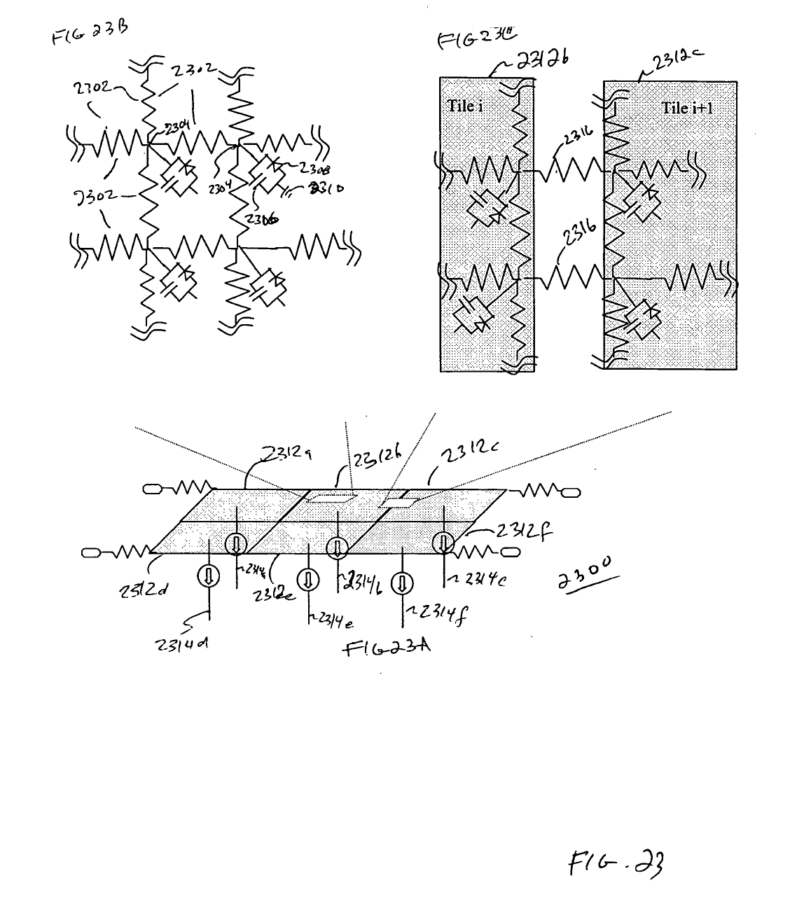

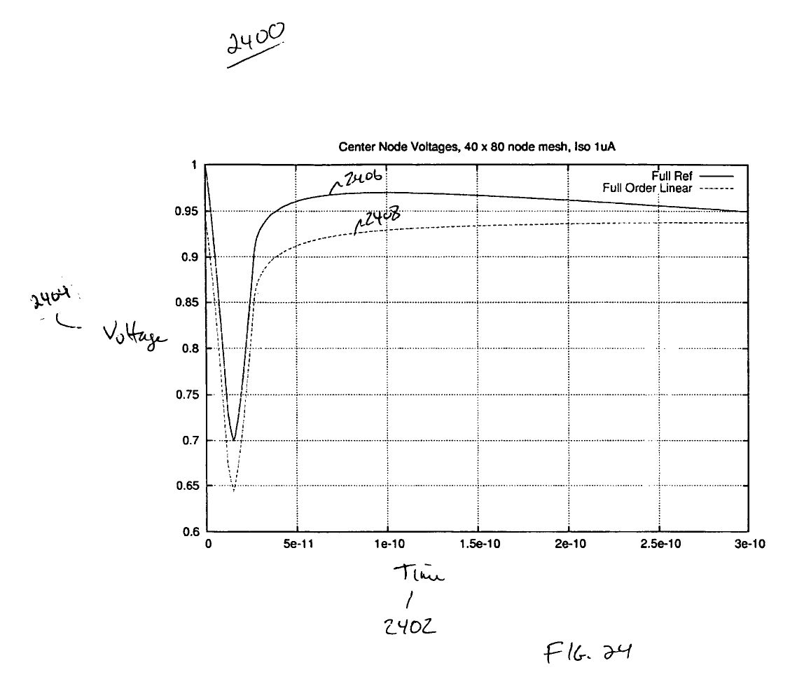

FIGS. 23-26 illustrate a non-linear mesh example of bi-directional local and global coupling according to an embodiment of the invention. FIG. 23A illustrates a non-linear two dimensional mesh 2300. FIGS. 23B and 23C illustrate exploded views of the mesh 2300. The mesh 2300 may be a power grid in an integrated circuit (IC). The mesh 2300 comprises four resistors 2302 at each interior node 2304 connecting to four neighboring nodes. At each node 2304, a capacitor 2306 and a diode 2308 are connected to a ground 2310. The diodes 2308 are reverse biased. The mesh corners are connected to the supply node through the four connecting resistors 2302. The mesh nodes are divided into tiles 2312. As shown in FIG. 23A, the mesh 2300 comprises a grid of 3×2 tiles. Each tile 2312 includes a center node 2304 to which a high impedance current source 2314 is attached.

As shown in FIG. 23C, the tiles 2312 are connected through connecting resistors 2316. These connecting resistors 2316 may constitute the remainder circuit H₀, and each tile 2312 may comprise a partition Hᵢ as in FIGS. 7, 8, and 9. The mesh 2300 can be decomposed in this manner according to an embodiment of the invention.

The approximations Ĥᵢ for the mesh 2300 are made using a reduced order model of the linearized impedance of Hᵢ. The resulting pre-viewer is a low order linear system that can be simulated efficiently.

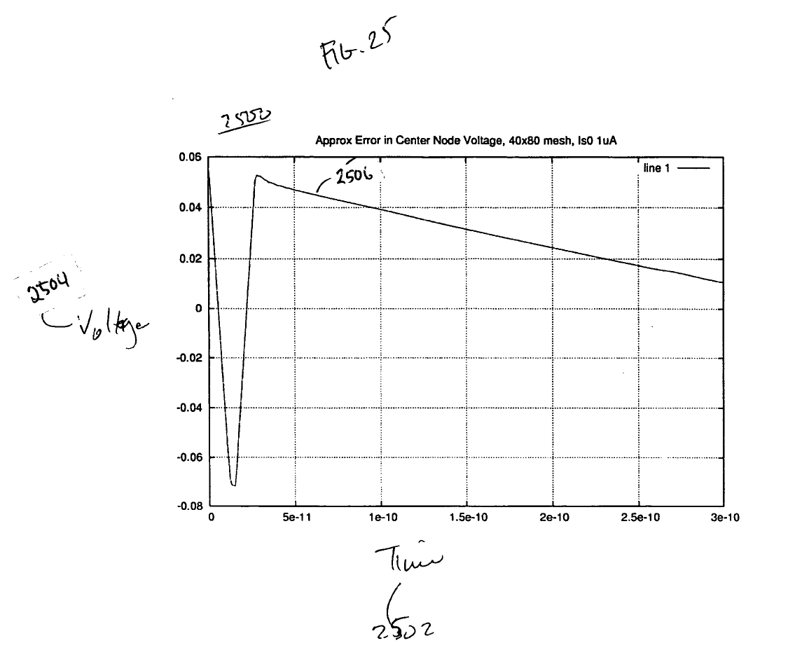

FIG. 24 illustrates a graph 2400 showing a center node voltage for a tile 2312 from a full reference simulation and from a full order linear approximation of the circuit 2300. The x-axis 2402 shows time and the y-axis 2404 show the voltage of the output. The plot 2406 shows the full reference simulation and the plot 2408 shows the full order linear approximation. The difference between the two plots 2406 and 2408 arises from the non-linearity of the diodes 2308.

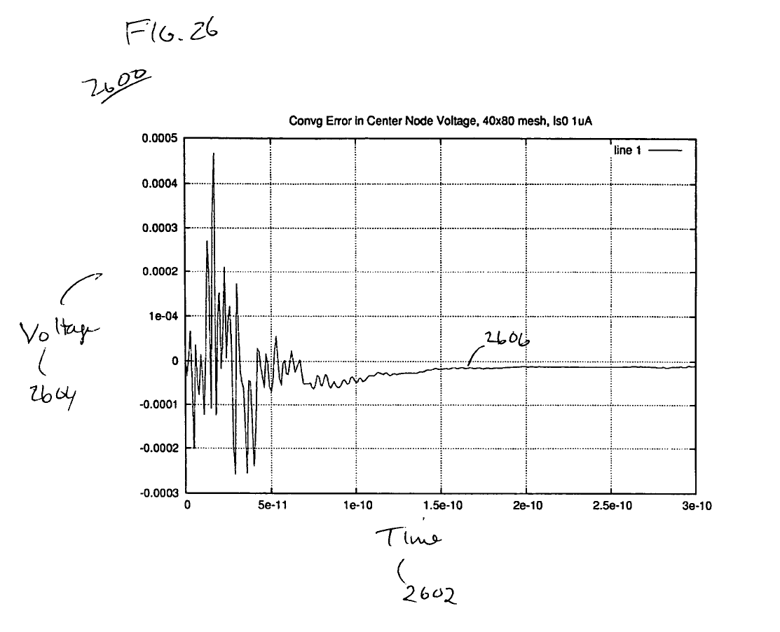

FIG. 25 illustrates the difference between the approximate low order pre-viewer response and the full reference system for a center node voltage of a tile 2312. Again, the x-axis 2502 shows time, and the y-axis 2504 shows voltage. The plot 2506 shows that the difference between the approximation and the full reference is considerable.

FIG. 26 is a graph showing the error of the voltage output of the simulation after three iterations using an embodiment of pre-viewer based approximation. The graph 2600 includes an x-axis 2602 showing time and a y-axis 2604 showing voltage. The plot 2606 shows that the error is well within accepted tolerances after only three iterations. In contrast, using the standard Gauss-Seidel decomposition, convergence takes over fifty iterations.

It is understood that the embodiments of the current invention are not limited to circuit simulations. For example, several other types of simulations, such as chemical simulations, biological simulations, automotive simulations, etc. may be performed using the systems and techniques described herein. These techniques can be adapted for a specific application.

This invention has been described with reference to specific exemplary embodiments thereof. It will, however, be evident to persons having the benefit of this disclosure that various modifications changes may be made to these embodiments without departing from the broader spirit and scope of the invention. The specification and drawings are accordingly to be regarded in an illustrative rather than in a restrictive sense.

What is claimed is:

1. A method comprising:
partitioning a system;
introducing approximated simulations of partitions to the system; and
simulating the system using the approximated simulations.

2. The method of claim 1, further comprising generating a pre-viewer comprising the approximated simulations.

3. The method of claim 1, wherein partition a system comprises:
identifying weak coupling based on inherent properties of the system;
dividing the system into the partitions based on the weak coupling.

4. The method of claim 1, wherein the simulating occurs after the introducing.

5. The method of claim 2, wherein generating a pre-viewer comprises:
generating a piecewise linear approximation from a lookup table.

6. The method of claim 1, wherein the simulating and the introducing are run in parallel on networked machines.

7. A machine readable medium having stored thereon executable program code which, when executed, causes a machine to perform a method, the method comprising:
partitioning a system;
introducing approximated simulations of partitions to the system; and
simulating the system using the approximated simulations.

8. The machine readable medium of claim 7, further comprising generating a pre-viewer comprising the approximated simulations.

9. The machine readable medium of claim 7, wherein partition a system comprises:
identifying weak coupling based on inherent properties of the system; and
dividing the system into the partitions based on the weak coupling.

10. The machine readable medium of claim 7, wherein the simulating occurs after the introducing.

11. The machine readable medium of claim 8, wherein generating a pre-viewer comprises:
generating a piecewise linear approximation from a lookup table.

12. The machine readable medium of claim 7, wherein the simulating and the introducing are run in parallel on networked machines.

13. A digital processing system, comprising:
a digital processor coupled to a display device;
a memory coupled to said digital processor, said memory receiving a system for simulation, said processor:
partitioning a system;
introducing approximated simulations of partitions to the system; and
simulating the system using the approximated simulations.

14. The digital processing system of claim 13, further comprising the processor generating a pre-viewer comprising the approximated simulations.

15. The digital processing system of claim 13, wherein partition a system comprises:
identifying weak coupling based on inherent properties of the system; and
dividing the system into the partitions based on the weak coupling.

16. The digital processing system of claim 13, wherein the simulating occurs after the introducing.

17. The digital processing system of claim 14, wherein generating a pre-viewer comprises:
generating a piecewise linear approximation from a lookup table.

18. The digital processing system of claim 13, wherein the simulating and the introducing are run in parallel on networked machines.
